(19) United States
(12) Patent Application Publication
(10) Pub. No.: US 2008/0098419 A1
(43) Pub. Date: Apr. 24, 2008

(54) Television Broadcasting Recording Apparatus

(75) Inventors: Kenji Okamoto, Daito-shi (JP); Takahiro Kurose, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/873,862

(22) Filed: Oct. 17, 2007

(30) Foreign Application Priority Data
Oct. 18, 2006 (JP) 2006-284067

(51) Int. Cl. H04N 7/16

(52) U.S. Cl. 725/28

(57) ABSTRACT

Disclosed is a television broadcasting recording apparatus including a television broadcasting recording apparatus including a receiving unit to receive a digital television broadcasting signal, a storage unit to store a video/audio data of a program based on the television broadcasting signal received by the receiving unit in a storage medium as an analog data, a detection unit to detect rating information regarding a parental control level of the program from the television broadcasting signal which is received by the receiving unit, a rating information type determination unit to determine a type of the rating information which is detected by the detection unit, a storage control unit to control the storage unit so as to prohibit storing of the video/audio data of the program in the storage medium when it is determined that the rating information of the program is rating information specific to digital broadcasting different from rating information of analog broadcasting by the rating information type determination unit.

### BACKGROUND OF THE INVENTION

1. Field of the Invention

The present invention relates to a television broadcasting recording apparatus.

2. Description of Related Art

Conventionally, there is known a television broadcasting receiving apparatus in which the information (rating information) of the parental control level is added to the video/audio data of the program in the broadcasting station side, and which restricts the viewing of the programs based on the rating information in order to prohibit children from watching the programs including violent expressions and the programs including indecent expressions.

However, when the program received by the television broadcasting receiving apparatus which can carry out the parental control are stored in the recording medium such as the VHS, the DVD or the like, the program becomes watchable by replaying the VHS, the DVD or the like even though a user desires to carry out the parental controlled for the program.

Therefore, there is known a television broadcasting recording apparatus which prohibits the storing of the program in the recording medium such as the VHS, the DVD or the like when the parental control level of the rating information is higher than a predetermined level (for example, JP2000-115680A). Further, there is known a television broadcasting recording apparatus which generates and sets parental control information according to the combinations of the channel number, the time zone, the genre and the like separately from the rating information which is set in the broadcasting station side, and which restricts the viewing, the storing and the replaying of the program based on the parental control information (for example, JP2001-145033A).

Moreover, there is also known a television broadcasting recording apparatus which carries out the parental control by superimposing the rating information onto the video/audio data to be stored in the recording medium of the record replay apparatus which stores the video/audio data of the program received by the television broadcasting receiving apparatus in the recording medium such as the VHS, the DVD or the like (for example, see JP2006-140678A and JP10-93952A).

Furthermore, there is also known a video/audio recording replay apparatus in which a password is set along with the prohibition of recording of the video/audio data in the recording medium such as the HDD, the DVD or the like, and in which only a user who inputs the password can release the prohibition of the storing of the video/audio data in the recording medium such as the HDD, the DVD or the like (for example, JP2006-149717A).

A television broadcasting receiving apparatus which is capable of displaying the EPG data on the display unit is also known (for example, JP2000-501273A).

Conventionally, the rating information is included in the video/audio data of the program by being superimposed onto the video/audio data for analog broadcasting, and the rating information is included in the augmentation data which is different from the video/audio data of the program for digital broadcasting. Here, the identical rating information is used for analog broadcasting and digital broadcasting.

When the video/audio data of digital broadcasting is stored in the recording medium such as the HDD, the DVD or the like as an analog video/audio data, the relevant parental control information is superimposed onto the video/audio data and is stored in the recording medium by referring to the rating information in the augmentation data included in digital broadcasting.

However, in digital broadcasting, rating information specific to digital broadcasting (for example, V-Chip2.0 in the U.S.) different from the conventional analog rating information will be newly added. The record replay apparatus cannot recognize the new rating information when the video/audio data of the program received by the digital broadcasting receiving apparatus is converted into analog data in the record replay apparatus and stored in the recording medium such as the VHS, the DVD or the like because the rating information specific to digital broadcasting is different from the rating information of analog broadcasting. Therefore, the video/audio data is stored in the recording medium without the parental control information being superimposed even when the program is the program which is desired to be parental controlled.

The above-mentioned inventions disclosed in JP2000-115680A, JP2006-140678A, and JP10-93952A cannot solve the problem because they are effective only when the rating information of digital broadcasting is same as the rating information of analog broadcasting.

Further, the invention disclosed in JP2001-145033A can set the parental control which is original to a user. However, there is a problem that the intentions of the broadcasting station is not reflected correctly because the parental control information is set separately from the rating information which is set in the broadcasting station side.

Moreover, the inventions disclosed in JP2006-149717A and JP2000-501273A cannot solve the above-mentioned problem because the inventions are not related to the rating information.

### SUMMARY OF THE INVENTION

It is, therefore, a main object of the present invention to provide a television broadcasting recording apparatus which can carry out the parental control more surely when the video/audio data of the program to which the rating information specific to digital broadcasting is added is stored in the storage medium as an analog data.

According to a first aspect of the present invention, there is provided a television broadcasting recording apparatus comprising a receiving unit to receive a digital television broadcasting signal, a storage unit to store a video/audio data of a program based on the television broadcasting signal received by the receiving unit in a storage medium as an analog data, an assigning unit to assign a reserved program to be stored in the storage medium by the storage unit, a reservation unit to store reservation information of the reserved program which is assigned by the assigning unit, by obtaining the reservation information from an electric program guide data, an obtaining unit to obtain rating information regarding a parental control level of the reserved program which is assigned by the assigning unit from the electric program guide data, a rating information type determination unit to determine a type of the rating information which is obtained by the obtaining unit, a display unit to display a predetermined warning display on the display unit when it is determined that the rating information of the program which is assigned by the assigning unit is the rating information specific to digital broadcasting different from the rating information of analog broadcasting by the rating information type determination unit, an input unit to input secret information and a secret information storage unit to store the secret information in advance, and the reservation unit stores the reservation information of the program in the reservation storage unit only in a case where the secret information input by the input unit matches with the secret information stored in the secret information storage unit when it is determined that the rating information of the program which is assigned by the assigning unit is the rating information specific to the digital broadcasting different from the rating information of the analog broadcasting by the rating information type determination unit.

According to a second aspect of the present invention, there is provided a television broadcasting recording apparatus comprising a receiving unit to receive a digital television broadcasting signal, a storage unit to store a video/audio data of a program based on the television broadcasting signal received by the receiving unit in a storage medium as an analog data, a detection unit to detect rating information regarding a parental control level of the program from the television broadcasting signal which is received by the receiving unit, a rating information type determination unit to determine a type of the rating information which is detected by the detection unit and a storage control unit to control the storage unit so as to prohibit storing of the video/audio data of the program in the storage medium when it is determined that the rating information of the program is rating information specific to digital broadcasting different from rating information of analog broadcasting by the rating information type determination unit.

According to a third aspect of the present invention, there is provided a television broadcasting recording apparatus comprising a receiving unit to receive a digital television broadcasting signal, a storage unit to store a video/audio data of a program based on the television broadcasting signal received by the receiving unit in a storage medium as an analog data, an assigning unit to assign a reserved program to be stored in the storage medium by the storage unit, a reservation unit to store reservation information of a reserved program which is assigned by the assigning unit in a reservation storage unit by obtaining the reservation information from an electric program guide data, an obtaining unit to obtain rating information regarding a parental control level of the reserved program which is assigned by the assigning unit from the electric program guide data and a rating information type determination unit to determine a type of the rating information which is obtained by the obtaining unit, and the reservation unit does not store the reservation information of the program in the reservation storage unit when it is determined that the rating information of the reserved program which is assigned by the assigning unit is rating information specific to digital broadcasting different from the rating information of analog broadcasting by the rating information type determination unit.

According to a forth aspect of the present invention, there is provided a television broadcasting recording apparatus comprising a receiving unit to receive a digital television broadcasting signal, a storage unit to store a video/audio data based on the television broadcasting signal of the program which is received by the receiving unit as an analog data, a detection unit to detect rating information regarding a parental control level of the program from the television broadcasting signal of the program which is received by the receiving unit, a rating information type determination unit to determine a type of the rating information which is detected by the detection unit, a determination unit to determine a parental control level of an analog rating information which corresponds to a parental control level of the rating information of the digital broadcasting based on a predetermined criteria when it is determined that the rating information included in the television broadcasting signal of the program is the rating information specific to the digital broadcasting different from the rating information of the analog broadcasting by the rating information type determination unit and a superimposing unit to superimpose parental control information of the parental control level of the analog rating information which is determined by the determination unit onto a video/audio data of a program to which the rating information specific to the digital broadcasting is added, and the storage unit stores the video/audio data to which the parental control information is superimposed by the superimposing unit in the storage medium.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an example of a schematic structure of the television broadcasting recording apparatus according to the first embodiment of the present invention;

FIG. 2 is a block diagram showing a structure of the television broadcasting recording apparatus according to the first embodiment of the present invention;

FIG. 3 is a flowchart for explaining an example of a recording operation in the television broadcasting recording apparatus according to the first embodiment of the present invention;

FIG. 4 is a block diagram showing a structure of the television broadcasting recording apparatus according to the second embodiment of the present invention;

FIG. 5 is a flowchart for explaining an example of a reservation operation in the television broadcasting recording apparatus according to the second embodiment of the present invention;

FIG. 6 is a block diagram showing a structure of the television broadcasting recording apparatus according to the third embodiment of the present invention; and

FIG. 7 is a flowchart for explaining an example of a storage operation in the television broadcasting recording apparatus according to the third embodiment of the present invention.

### DESCRIPTION OF THE PREFERRED EMBODIMENTS

Hereinafter, the best mode for implementing the television broadcasting recording apparatus according to the present invention will be described in detail with reference to drawings.

### First Embodiment

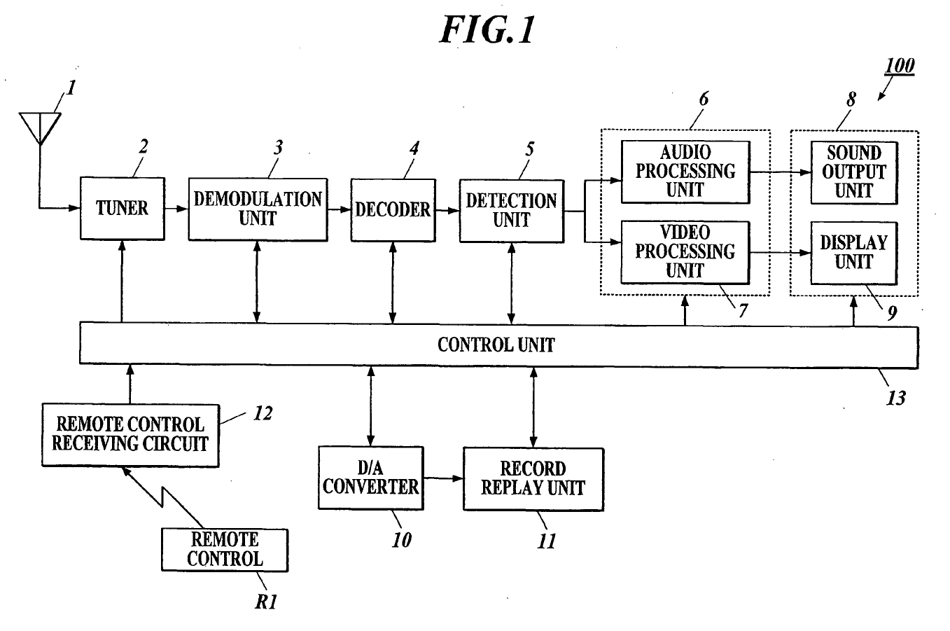

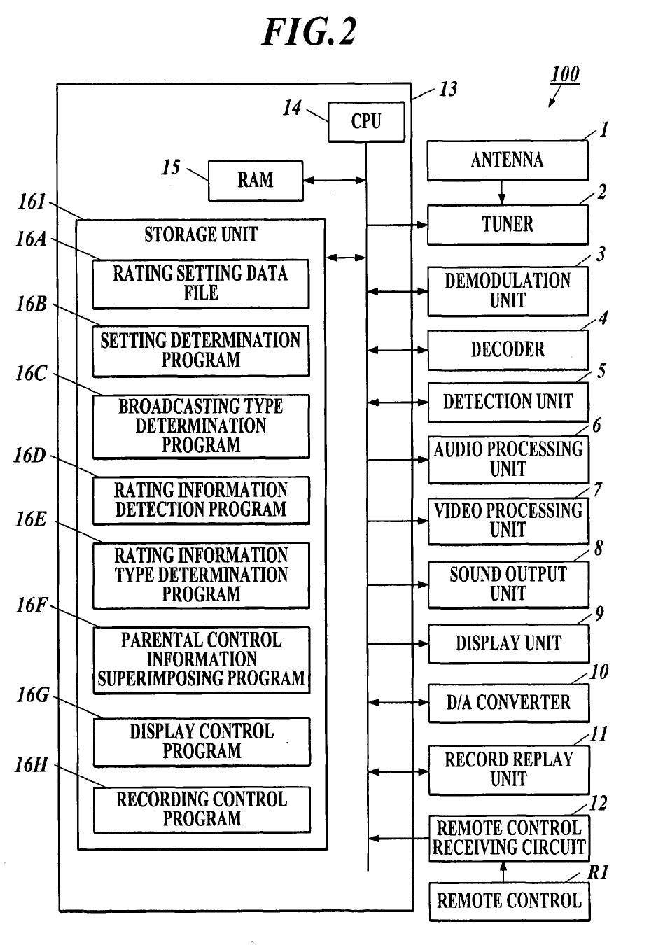

First, a television broadcasting recording apparatus 100 according to the first embodiment of the present invention will be described with reference to FIGS. 1 and 2. For example, the television broadcasting recording apparatus 100 according to the first embodiment comprises an antenna 1, a tuner 2, a demodulation unit 3, a decoder 4, a detection unit 5, an audio processing unit 6, a video processing unit 7, a sound output unit 8, a display unit 9, a D/A converter 10, a record replay unit 11, a remote control receiving circuit 12, a remote control R1, a control unit 13 and the like as shown in FIGS. 1 and 2.

For example, the antenna 1 is a parabola antenna, a UHF antenna or the like. The antenna 1 receives the broadcasting wave including the television broadcasting signals of terrestrial analog broadcasting, terrestrial digital broadcasting, BS/CS broadcasting and the like, and outputs the RF signals which are the terrestrial analog signal, the terrestrial digital signal, the BS/CS broadcasting signal and the like to the tuner 2. Thereby, the antenna 1 functions as a receiving unit. Here, when the broadcasting wave is received via the CATV circuit, the connection cable (omitted from the drawing) or the like may be provided.

The tuner 2 comprises a mixer (omitted from the drawing), a tuning circuit (omitted from the drawing), an A/D converter circuit (omitted from the drawing) and the like. The RF signal input from the antenna 1 by the mixer, the tuning circuit or the like is converted into the IF (Intermediate Frequency) signal of the channel which is requested by a user, and the generated IF signal is converted into a digital data by the A/D converter circuit.

For example, the demodulation unit 3 carries out a demodulation process or the like for the digital data which is input from the tuner unit 2, and outputs the demodulated digital data to the decoder 4.

For example, the decoder 4 generates the video/audio data (video data and audio data) of the program and the rating information which is added to the video/audio data by carrying out the demodulation process or the like for the digital data which is input from the demodulation unit 3, and outputs the video/audio data and the rating information to the detection unit 5. Here, the rating information is information regarding the parental control level of the program.

More particularly, for example, rating information defined by MPAA (Motion Picture Association of America), rating information defined by TV Parental Guidelines and the like are known as the conventional rating information. Among these rating information, for example, there are rating information indicating the parental control level of each program according to age and rating information indicating the parental control level of each program according to the content of the program, and they are used for both analog television broadcasting and digital television broadcasting.

Moreover, rating information specific to the digital broadcasting (for example, V-Chip2.0 in the U.S.) is newly established. Differently from the conventional rating information, the rating information specific to digital broadcasting indicates the parental control level of each program according to the rating items defined by the genre or the like of the program and the rating level defined for each rating item.

The detection unit 5 is controlled by the control signal which is input from the control unit 13, and functions as a detection unit by detecting the rating information added to the video/audio data which is output from the decoder 4.

For example, the audio processing unit 6 comprises a mute circuit (omitted from the drawing) and the like. The audio processing unit 6 carries out the mute process or the like for the audio data which is output from the decoder 4 by being controlled by the control signal which is input from the control unit 13.

For example, the video processing unit 7 comprises a mute circuit (omitted from the drawing) and the like. The video processing unit 7 carries out the mute process or the like for the video data which is output from the decoder 4 by being controlled by the control signal which is input from the control unit 13. Further, for example, the video processing unit 7 combines the OSD display data for displaying a predetermined warding display on the display unit 9 to the video data which is output from the decoder 4 by being controlled by the control signal which is input from the control unit 13.

For example, the sound output unit 8 comprises a speaker or the like, and outputs the audio based on the audio data which is output from the audio processing unit 6.

For example, the display unit 9 comprises the LCD (Liquid Crystal Display), the PDP (Plasma Display Panel) or the like, and displays the video based on the video data which is output from the video processing unit 7.

For example, the D/A converter 10 carries out the digital/analog conversion to the video/audio data and the rating information which are input from the decoder 4, and outputs the converted video/audio data and rating information to the record replay unit 11.

For example, the record replay unit 11 is a record replay device of the storage medium such as the DVD, the VHS or the like. The record replay unit 11 stores the video/audio data and the rating information which are input from the D/A converter 10 in the storage medium, and regenerates the video/audio data which is stored in the storage medium. Thereby, the record replay unit 11 functions as a storage unit and a replay unit.

For example, the remote control receiving circuit 12 outputs the operation signal which is output from the remote control R1 to the control unit 13. More particularly, the remote control receiving circuit 12 converts the infrared signal from the remote control R1 into the electric signal, and outputs the electric signal to the control unit 13.

For example, the remote control R1 comprises various types of keys or the like to input various types of operation signal. The remote control R1 outputs the various types of operation signal to the control unit 13 via the remote control receiving circuit 12 by a user operating the remote control R1.

For example, the control unit 13 comprises a CPU (Central Processing Unit) 14, a RAM (Random Access Memory) 15, a storage unit 16 and the like as shown in FIG. 2.

For example, the CPU 14 reads the processing program or the like which is stored in the storage unit 16, and expands the program in the RAM 15 and executes the program. Thereby, the CPU 14 controls the entire television broadcasting recording apparatus 100.

The RAM 15 expands the processing program or the like which is executed by the CPU 14 in the program storage region in the RAM 15, and stores the input data and the processing result and the like which are generated when the processing programs are executed in the data storage region.

For example, the storage unit 16 comprises a recording medium (omitted from the drawing) in which programs, data and the like are stored in advance, and for example, the recording medium is constituted of a semiconductor memory or the like. Further, the storage unit 16 stores various types of data and various types of processing programs to make the CPU 14 to realize the function of controlling the entire television broadcasting recording apparatus 100, the data which are processed by executing these programs and the like. More particularly, for example, the storage unit 16 stores a rating setting data file 16A, a setting determination program 16B, a broadcasting type determination program 16C, a rating information detection program 16D, a rating information type determination program 16E, a parental control information superimposing program 16F, a display control program 16G, a recording control program 16H and the like.

For example, the rating setting data file 16A stores the rating information of the parental control level which restricts the viewing in the television broadcasting recording apparatus 100.

For example, the setting determination program 16B is a program to make the CPU 14 realize the function of determining whether the parental control is set or not by determining whether the rating information of the parental control level which restricts the viewing in the television broadcasting recording apparatus 100 is stored in the rating setting data file 16A or not.

For example, the broadcasting type determination program 16C is a program to make the CPU 14 realize the function of determining whether the program is digital broadcasting or not by referring to the program information included in the television broadcasting signal of the program which is received by the antenna 1 and decoded by the decoder 4.

For example, the rating information detection program 16D is a program to make the CPU 14 realize the function of detecting the rating information from the television broadcasting signal of the program which is received by the antenna 1. More particularly, the rating information detection program 16D is a program to make the CPU 14 realize the function of determining whether the rating information is included in the television broadcasting signal of the program or not by the detection unit 5. The CPU 14 functions as a detection unit along with the detection unit 5 by executing the rating information detection unit.

For example, the rating information type determination program 16E is a program to make the CPU 14 realize the function of determining the type of the rating information which is detected by the detection unit 5. More particularly, for example, the rating information type determination program 16E is a program to make the CPU 14 realize the function of determining whether the rating information is the rating information specific to digital broadcasting different from the rating information of analog broadcasting or not based on the existence or non-existence of the name and the version of the rating information which is detected by the detection unit 5, or the like. The CPU 14 functions as the rating information type determination unit by executing the rating information type determination program 16E.

For example, the parental control information superimposing program 16F is a program to make the CPU 14 realize the function of superimposing the parental control information which corresponds to the rating information onto the video/audio data when it is determined that the program is digital broadcasting by referring to the program information included in the television broadcasting signal of the program which is decoded by the decoder 4 by the CPU 14 executing the broadcasting type determination program 16C, and when it is determined that the type of the rating information included in the television broadcasting signal of the program is same as the rating information of analog broadcasting by the CPU 14 executing the rating information type determination program 16E.

For example, the display control program 16G is a program to make the CPU 14 realize the function of displaying a predetermined warning display by controlling the display unit 9 when it is determined that the type of the rating information included in the television broadcasting signal of the program is the rating information specific to digital broadcasting different from the rating information of analog broadcasting by the CPU 14 executing the rating information type determination program 16E. Here, the predetermined warning display is a display such as “This program cannot be recorded due to parental control function” or the like, for example. The CPU 14 functions as a display control unit by execution the display control program 16G.

For example, the recording control program 16H is a program to make the CPU 14 realize the function of controlling the record replay unit 11 so as to store the video/audio data of the program in the recording medium when it is determined that the parental control is not set by the CPU 14 executing the setting determination program 16B, when it is determined that the program is analog broadcasting by the CPU 14 executing the broadcasting type determination program 16C, and when it is determined that the rating information is not included in the television broadcasting signal of the program by the CPU 14 executing the rating information detection program 16D.

Moreover, for example, the recording control program 16H is a program to make the CPU 14 realize the function of controlling the record replay unit 11 so as to store the video/audio data of the program in which the parental control information is superimposed by the CPU 14 executing the parental control information superimposing program 16F in the recording medium when it is determined that the type of the rating information included in the television broadcasting signal of the program is same as the rating information of analog broadcasting by the CPU 14 executing the rating information type determination program 16E.

Further, for example, the recording control program 16H, is a program to make the CPU 14 realize the function of controlling the record replay unit 11 so as to prohibit the storing of the video/audio data of the program in the recording medium when it is determined that the type of the rating information included in the television broadcasting signal of the program is the type of the rating information specific to digital broadcasting different from the rating information of analog broadcasting by the CPU 14 executing the rating information type determination program 16E.

The CPU 14 functions as a storage control unit by executing the recording control program 16H.

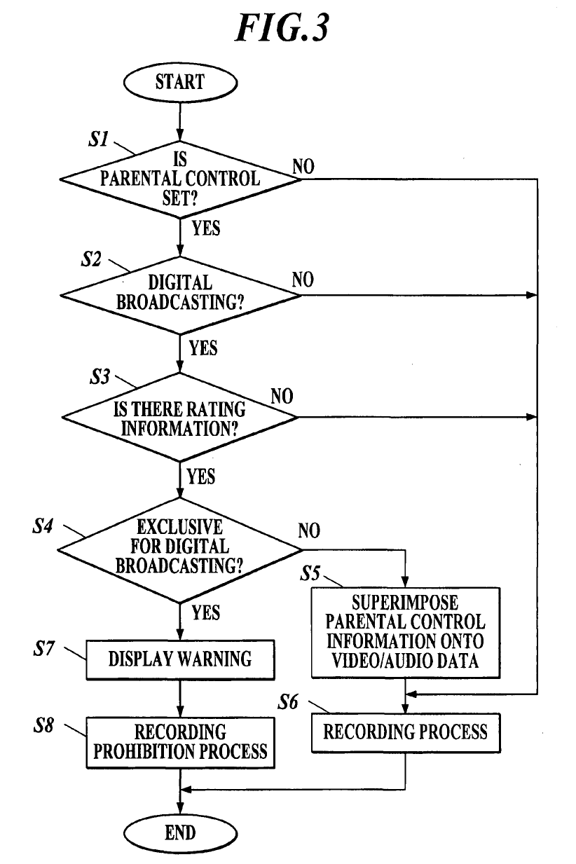

Next, the operation of storing the video/audio data in the storage medium in the television broadcasting recording apparatus 100 having the above-mentioned structure will be described with reference to the flowchart shown in FIG. 3.

First, the CPU 14 determines whether the parental control is set or not (step S1) by determining whether the rating information of the parental control level which restricts the viewing in the television broadcasting recording apparatus 100 is stored in the rating setting data file 16A or not by the CPU 14 executing the setting determination program 16B.

When the CPU 14 determines that the parental control is not set in step S1 (step S1; No), the process proceeds to step S6.

When the CPU 14 determines that the parental control is set in step S1 (step S1; Yes), the CPU 14 determines whether the program is digital broadcasting or not (step S2) by referring to the program information included in the television broadcasting signal of the program which is received by the antenna 1 and decoded by the decoder 4 by the CPU 14 executing the broadcasting type determination program 16C.

When the CPU 14 determines that the program received by the antenna 1 is analog broadcasting in step S2 (step S2; No), the process proceeds to step S6.

When the CPU 14 determines that the program received by the antenna 1 is digital broadcasting in step S2 (step S2; Yes), the CPU 14 determines whether the rating information is added to the video/audio data of the program or not by controlling the detection unit 5 by the CPU 14 executing the rating information detection program 16D (step S3).

When the CPU 14 determines that the rating information is not added to the video/audio data of the program in step S3 (step S3; No), the process proceeds to step S6.

When the CPU 14 determines that the rating information is added to the video/audio data of the program in step S3 (step S3; Yes), the CPU 14 determines whether the rating information is the rating information specific to digital broadcasting different from the rating information of analog broadcasting or not (step S4) based on the existence or non-existence of the name and the version of the rating information which is detected by the detection unit 5 or the like by the CPU 14 executing the rating information type determination program 16E.

When the CPU 14 determines that the rating information included in the television broadcasting signal of the program which is received by the antenna 1 is not the rating information specific to digital broadcasting in step S4 (step S4; No), the CPU 14 superimposes the parental control information which corresponds to the rating information onto the video/audio data (step S5) by the CPU 14 executing the parental control information superimposing program 16F.

Next, the CPU 14 controls the record replay unit 11 so as to store the video/audio data of the program in the recording medium (step S6) by the CPU 14 executing the recording control program 16H.

When the CPU 14 determines that the rating information included in the television broadcasting signal of the program which is received by the antenna 1 is the rating information specific to digital broadcasting in step S4 (step S4; Yes), the CPU 14 displays the predetermined warning display such as “This program cannot be recorded due to parental control function” or the like, for example, by controlling the control unit 9 by the CPU 14 executing the display control program 16G (step S7).

Next, the CPU 14 controls the record replay unit 11 so as to prohibit the storing of the video/audio data of the program in the recording medium (step S8) by the CPU 14 executing the recording control program 16H.

According to the television broadcasting recording apparatus 100 of the above described first embodiment of the present invention, the detection unit 5 is controlled and the rating information regarding the parental control level of the program is detected from the television broadcasting signal of the program which is received by the antenna 1 by the CPU 14 executing the rating information detection program 16D, the type of the rating information which is detected by the detection unit 5 is determined by the CPU 14 executing the rating information type determination program 16E, and the record replay unit 11 is controlled so as to prohibit the storing of the video/audio data of the program in the storage medium by the CPU 14 executing the recording control program 16H when it is determined that the rating information of the program is the rating information specific to digital broadcasting different from the rating information of analog broadcasting by the CPU 14 executing the rating information type determination program 16E. Therefore, the video/audio data of the program to which the rating information specific to digital broadcasting different from the rating information of analog broadcasting is added is not stored in the storage medium, and the video/audio data of the program to which the rating information specific to digital broadcasting different from the rating information of analog broadcasting can be prevented from being stored in the storage medium without having the parental control information superimposed onto the video/audio data and the parental control can be more surely effective when the video/audio data of the program to which the rating information specific to digital broadcasting is added is stored in the storage medium as an analog data.

Moreover, the predetermined warning display is displayed on the display unit 9 by the CPU 14 executing the display control program 16G when it is determined that the rating information of the program which is detected by the detection unit 5 is the rating information specific to digital broadcasting different from the rating information of analog broadcasting by the CPU 14 executing the rating information type determination program 16E. Therefore, even when the video/audio data of the program to which the rating information specific to digital broadcasting different from the rating information of analog broadcasting is added is not stored in the storage unit, it can be prevented from falsely recognizing as a breakdown by visually recognizing the predetermined warning display which is displayed on the display unit 9.

### Second Embodiment

In a television broadcasting recording apparatus 200 according to the second embodiment of the present invention, for example, only the structures of a storage unit 160 and a remote control R2 are different from the television broadcasting recording apparatus 100 according to the first embodiment. Therefore, the same reference numerals are used for the same structures and the descriptions are omitted.

For example, the remote control R2 comprises various types of keys or the like to input various types of operation signals, and outputs the various types of operation signals to the control unit 13 via the remote control receiving circuit 12 by being operated by a user.

More particularly, the remote control R2 functions as an assigning unit by inputting the operation signal for assigning the reserved program which is to be stored in the storage medium by the record replay unit 11 to the control unit 13 by assigning the program from the EPG (Electric Program Guide) which is displayed on the display unit 9.

Moreover, the remote control R2 functions as an input unit by inputting the password as secret information in the control unit 13.

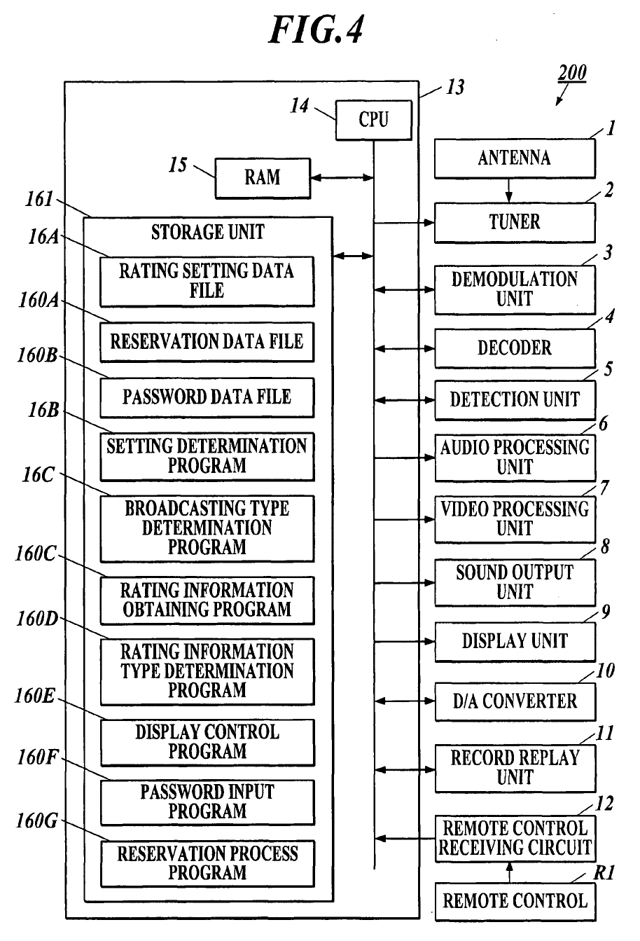

For example, the storage unit 160 comprises a recording medium (omitted from the drawing) in which programs, data and the like are stored in advance, and for example, the recording medium is constituted of a semiconductor memory or the like. Further, the storage unit 160 stores various types of data and various types of processing programs to make the CPU 14 realize the function of controlling the entire television broadcasting recording apparatus 200, the data which are processed by executing these programs and the like. More particularly, for example, the storage unit 160 stores the rating setting data file 16A, a reservation data file 160A, a password data file 160B, the setting determination program 16B, the broadcasting type determination program 16C, a rating information obtaining program 160C, the rating information type determination program 160D, a display control program 160E, a password input program 160F, a reservation processing program 160G and the like as shown in FIG. 4.

For example, the reservation data file 160A stores the reservation information of the reserved program which is to be stored in the storage medium by the record replay unit 11. Here, for example, the reservation information is information such as the broadcasting channel, the broadcasting starting time, the broadcasting ending time and the like of the reserved program. The storage unit 160 functions as a reservation storage unit by storing the reservation data file 160A.

For example, the password data file 160B stores the password as secret information which is preset in the television broadcasting recording apparatus 200. The password may be set at the time of shipment of the television broadcasting recording apparatus 200 from the factory, or may be set in advance by a user.

For example, the rating information obtaining program 160C is a program to make the CPU 14 realize the function of obtaining the rating information of the reserved program which is assigned by the remote control R2 from the EPG data. More particularly, for example, the rating information obtaining program 160C is a program to make the CPU 14 realize the function of obtaining the rating information from the EPG data when it is found that the rating information is added to the reserved program by determining whether the rating information is added to the reserved program which is assigned by the remote control R2 or not by referring to the EPG data. The CPT 14 functions as a rating information obtaining unit by executing the rating information obtaining program 160.

For example, the rating information type determination program 160D is a program to make the CPU 14 realize the function of determining the type of the rating information obtained by the rating information obtaining program 160C and determining whether the rating information is the rating information specific to digital broadcasting different from the rating information of analog broadcasting or not. The CPU 14 functions as a rating information type determination unit by executing the rating information type determination program 160D.

For example, the display control program 160E is a program to make the CPU 14 realize the function of displaying a predetermined warning display on the display unit 9 when it is determined that the rating information of the reserved program which is assigned by the remote control R2 is the rating information specific to digital broadcasting different from the rating information of analog broadcasting by the CPU 14 executing the rating information type determination program 160D. Here, for example, the predetermined warning display is such as “Parental control function will be released when this program is recorded. OK?” or the like. The CPU 14 functions as a display control unit by executing the display control program 160E.

For example, the password input program 160F is a program to make the CPU 14 realize the function of inducing the password input when the reservation of the storing of the video/audio data to which the rating information specific to digital broadcasting different from the rating information of analog broadcasting is added in the storage medium of the record replay unit 11 is carried out by determining that the rating information of the reserved program assigned by the remote control R2 is the rating information specific to digital broadcasting different from the rating information of analog broadcasting by the CPU 14 executing the rating information type determination program 160D and by displaying “Please set password when programming recording reservation” or the like, for example, on the display unit 9 when “Yes” is selected by the remote control while “Parental control will be released when this program is recorded. Ok?” is displayed on the display unit 9 as a predetermined warning display.

For example, the reservation processing program 160G is a program to make the CPU 14 realize the function of storing the program information in the reservation data file 160A by obtaining the program information of the reserved program which is assigned by the remote control R2 from the EPG data.

More particularly, for example, the reservation processing program 160G is a program to make the CPU 14 store the reservation information of the reserved program in the reservation data file 160A when it is determined that the rating information of the reserved program which is assigned by the remote control R2 is not the rating information specific to digital broadcasting different from the rating information of analog broadcasting by the CPU 14 executing the rating information type determination program 160D, and to make the CPU 14 realize the function of storing the reservation information of the reserved program in the reservation data file 160A only in a case where the password input by the remote control R2 matches with the password stored in the password data file 160B when it is determined that the rating information of the reserved program which is assigned by the remote control R2 is the rating information specific to digital broadcasting different from the rating information of analog broadcasting by the CPU 14 executing the rating information type determination program 160D.

The CPU 14 functions as a reservation unit by executing the reservation processing program 160G.

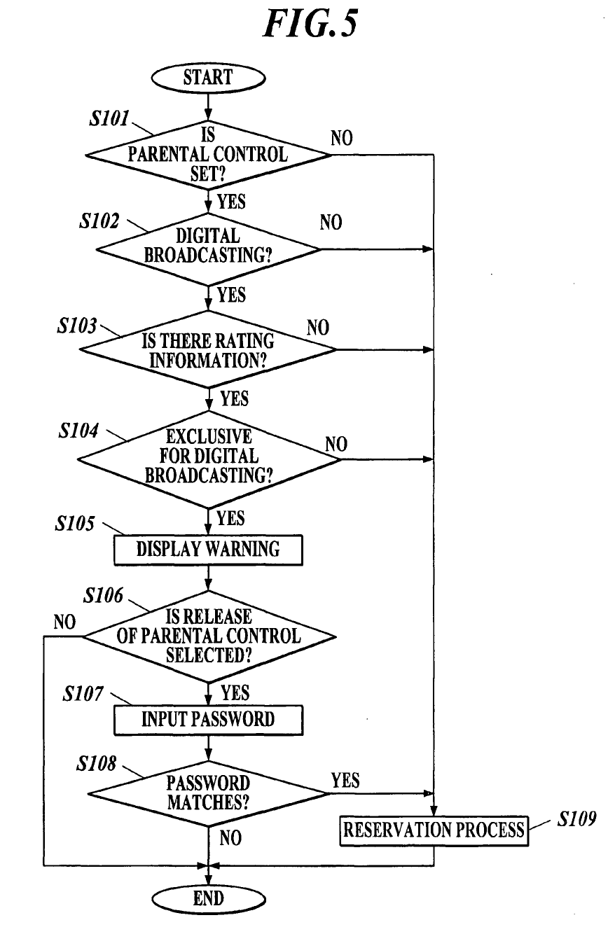

Next, the reservation operation of the television broadcasting recording apparatus 200 according to the above described second embodiment of the present invention will be described with reference to the flowchart shown in FIG. 5.

First, the CPU 14 determines whether the parental control is set or not (step S101) by determining whether the rating information of the parental control level which restricts the viewing in the television broadcasting recording apparatus 100 is stored in the rating setting data file 16A or not by the CPU 14 executing the setting determination program 16B.

When the CPU 14 determines that the parental control is not set in step S101 (step S101; No), the process proceeds to step S109.

When the CPU 14 determines that the parental control is set in step S101 (step S101; Yes), the CPU 14 determines whether the program is digital broadcasting or not (step S 102) by referring to the program information included in the television broadcasting signal of the program which is received by the antenna 1 and decoded by the decoder 4 by the CPU 14 executing the broadcasting type determination program 16C.

When the CPU 14 determines that the program received by the antenna 1 is analog broadcasting in step S102 (step S102; No), the process proceeds to step S109.

When the CPU 14 determines that the program received by the antenna 1 is digital broadcasting in step S102 (step S102; Yes), the CPU 14 determines whether the rating information is added to the reserved program which is assigned by the remote control R2 or not (step S103) by referring to the EPG data by the CPU 14 executing the rating information obtaining program 160C.

When the CPU 14 determines that the rating information is not added to the reserved program in step S103 (step S103; No), the process proceeds to step S109.

When the CPU 14 determines that the rating information is added to the reserved program in step S103 (step S103; Yes), the CPU 14 determines whether the rating information is the rating information specific to digital broadcasting which is different from the rating information of analog broadcasting or not by obtaining the rating information from the EPG data based on the CPU 14 executing the rating information obtaining program 160C, and based on the existence or non-existence of the name and the version of the obtained rating information (step S104) by the CPU 14 executing the rating information type determination program 160D.

When the CPU 14 determines that the rating information added to the reserved program which is assigned by the remote control R2 is not the rating information specific to digital broadcasting in step S104 (step S104; No), the process proceeds to step S109.

When the CPU 14 determines that the rating information added to the reserved program which is assigned by the remote control R2 is the rating information specific to digital broadcasting in step S104 (step S104; Yes), the CPU 14 controls the control unit 9 so as to display the predetermined warning display such as “Parental control function will be released when this program is recorded. OK?” or the like (step S105) by the CPU 14 executing the display control program 160E.

Next, the CPU 14 determines whether “Yes” is selected from the remote control R1 or not when “Parental control function will be released when this program is recorded. OK?” is displayed on the display unit 9 as the predetermined warning display or not (step S106) by the CPU 14 executing the password input program 160F.

When the CPU 14 determines that “Yes” is not selected from the remote control R1 in step S106 (step S106; No), the process is ended.

When the CPU 14 determines that “Yes” is not selected from the remote control R1 in step S106 (step S106; No), the CPU 14 makes the display unit 9 display, for example, “Please set password when setting recording reservation” or the like based on the execution of the password input program 160F by the CPU 14 and the password input is induced (step S107).

Next, the CPU 14 determines whether the password input from the remote control R2 matches with the password stored in the password data file 160B (step S108) by the CPU 14 executing the reservation processing program 160G.

When the CPU 14 determines that the password input from the remote control R2 does not match with the password stored in the password data file 160B in step S108 (step S108; No), the process is ended.

When the CPU 14 determines that the password input from the remote control R2 matches with the password stored in the password data file 160B in step S108 (step S108; Yes), the CPU 14 stores the reservation information of the reserved program in the reservation data file 160A (step S109) based on the execution of the reservation processing program 160G by the CPU 14.

According to the television broadcasting recording apparatus 200 of the above described second embodiment of the present invention, the reserved program to be stored in the storage medium by the record replay unit 11 is assigned by the remote control R2, the reservation information of the reserved program which is assigned by the remote control R2 is obtained from the EPG (Electric Program Guide) data and stored in the reservation data file 160A by the CPU 14 executing the reservation processing program 160G, the rating information relating to the parental control level of the reserved program which is assigned by the remote control R2 is obtained from the EPG data by the CPU 14 executing the rating information obtained program 160C, and the type of the rating information obtained by the CPU 14 executing the rating information obtaining program 160C is determined by the CPU 14 executing the rating information type determination program 160D. Further, the reservation information of the program to which the rating information specific to digital broadcasting different from the rating information of analog broadcasting is not stored in the reservation data file 160A by the CPU 14 executing the reservation processing program 160G because the reservation information of the program is not stored in the reservation data file 160A when it is determined that the rating information of the reserved program which is assigned by the remote control R2 is the rating information specific to digital broadcasting which is different from the rating information of analog broadcasting by executing the rating information type determination program 160D. Therefore, the video/audio data of the program to which the rating information specific to digital broadcasting different from the rating information of analog broadcasting can be prevented from being stored in the storage medium without having the parental control information superimposed, and the parental control can be more surely effective when the video/audio data of the program to which the rating information specific to digital broadcasting is added is stored in the storage medium as an analog data.

Moreover, the predetermined warning display is displayed on the display unit 9 by the CPU 14 executing the display control program 160E when it is determined that the rating information of the program which is assigned by the remote control R2 is the rating information specific to digital broadcasting different from the rating information of analog broadcasting by the CPU 14 executing the rating information type determination program 160D. Therefore, it can be prevented from falsely recognizing as a breakdown by visually recognizing the predetermined warning display which is displayed on the display unit 9 even when the reservation information of the program to which the rating information specific to digital broadcasting different from the rating information of analog broadcasting is added is not stored in the reservation data file 160A.

Furthermore, the password is input by the remote control R2, the password is stored in advance by the password data file 160B, and the reservation information of the program is stored in the reservation data file 160A by the CPU 14 executing the reservation processing program 160G only in a case where the password input by the remote control R2 matches with the password stored in the password data file 160B when it is determined that the rating information of the program which is assigned by the remote control R2 is the rating information specific to digital broadcasting which is different from the rating information of analog broadcasting by the CPU 14 executing the rating information type determination program 160D. Therefore, the television broadcasting recording apparatus 200 is convenient to use because a person who can input the password can set the reservation for a program even when it is a program to which the rating information specific to digital broadcasting different from the rating information of analog broadcasting is added.

### Third Embodiment

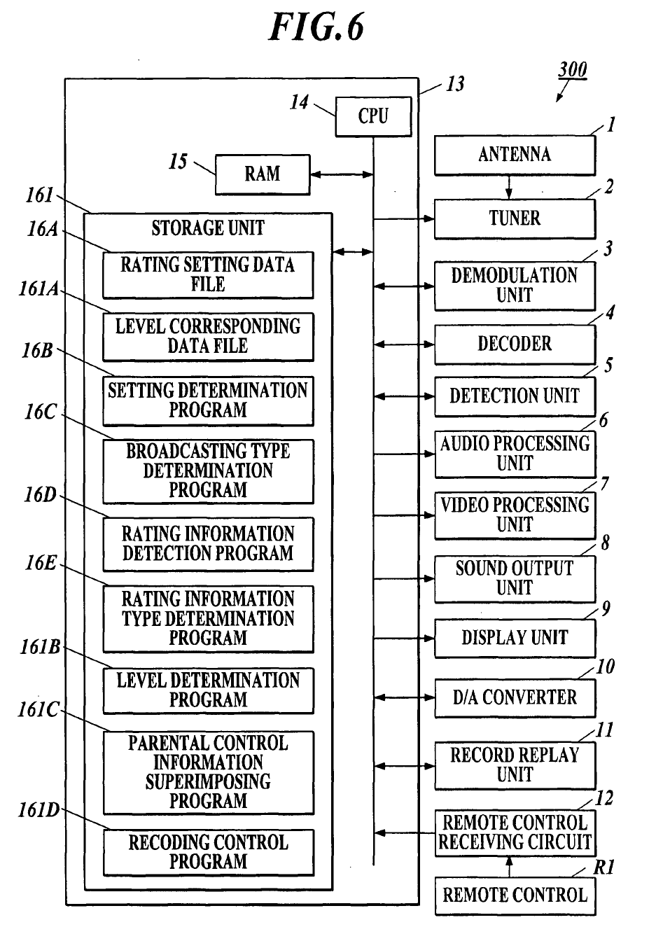

In a television broadcasting recording apparatus 300 according to the third embodiment of the present invention, for example, only the structure of a storage unit 161 is different from the television broadcasting recording apparatus 100 according to the first embodiment as shown in FIG. 6. Therefore, same reference numerals are used for the same structures and the descriptions are omitted.

For example, the storage unit 161 comprises a recording medium (omitted from the drawing) in which programs, data and the like are stored in advance, and for example, the recording medium is constituted of a semiconductor memory or the like. Further, the storage unit 161 stores various types of data and various types of processing programs to make the CPU 14 realize the function of controlling the entire television broadcasting recording apparatus 300, the data which are processed by executing these programs and the like. More particularly, for example, the storage unit 161 stores the rating setting data file 16A, a level corresponding data file 161A, the setting determination program 16B, the broadcasting type determination program 16C, the rating information detection program 16D, the rating information type determination program 16E, a level determination program 161B, a parental control information superimposing program 161C, a recording control program 161D and the like as shown in FIG. 6.

For example, the level corresponding data file 161A stores the correspondence between the parental control level indicated by the rating information which is used in conventional analog broadcasting and the parental control level indicated by the rating information specific to digital broadcasting which is newly established. Particularly, for example, the level corresponding data file 161A stores the correspondence regarding to which parental control level in the rating information used in conventional analog broadcasting one of the parental control level in the rating information specific to digital broadcasting which is newly established corresponds to.

The correspondence in the level corresponding data file 161A may be set in advance at the time of shipment of the television broadcasting recording apparatus 300 from the factory, or may be set by a user. Further, the level corresponding data file 161A is rewritable so that the correspondence between the parental control level indicated by the rating information after the change and the parental control level indicated by the rating information used in conventional analog broadcasting can be set when the rating information specific to digital broadcasting is changed.

For example, the level determination program 161B is a program to make the CPU 14 realize the function of determining the parental control level of the analog rating information which corresponds to the parental control level of the rating information specific to digital broadcasting based on the level corresponding data file 161A when it is determined that the rating information included in the television broadcasting signal of the program is the rating information specific to digital broadcasting different from the rating information of analog broadcasting by the CPU 14 executing the rating information type determination program 16E. The CPU 14 functions as a determination unit by executing the level determination program 161B.

For example, the parental control information superimposing program 161C is a program to make the CPU 14 realize the function of superimposing the parental control information which corresponds to the rating information onto the video/audio data when it is determined that the program is digital broadcasting by referring to the program information included in the television broadcasting signal of the program which is decoded by the decoder 4 by the CPU 14 executing the broadcasting type determination program 16C and when it is determined that the type of the rating information included in the television broadcasting signal of the program is same as the rating information of analog broadcasting by the CPU 14 executing the rating information type determination program 16E.

Moreover, for example, the parental control information superimposing program 161A is a program to make the CPU 14 realize the function of superimposing the parental control information which corresponds to the parental control level determined by the CPU 14 executing the level determination program 161B onto the video/audio data.

The CPU 14 functions as a superimposing unit by executing the parental control information superimposing program 161C.

For example, the recording control program 161D is a program to make the CPU 14 realize the function of controlling the record replay unit 11 so as to store the video/audio data of the program in the recording medium when it is determined that the parental control is not set by the CPU 14 executing the setting determination program 16B, when it is determined that the program is analog broadcasting by the CPU 14 executing the broadcasting type determination program 16C, and when it is determined that the rating information is not included in the television broadcasting signal of the program by the CPU 14 executing the rating information detection program 16D.

Moreover, for example, the recording control program 161D is a program to make the CPU 14 realize the function of controlling the record replay unit 11 so as to store the video/audio data of the program to which the parental control information is superimposed by the CPU 14 executing the parental control information superimposing program 161C in the recording medium when it is determined that the type of the rating information included in the television broadcasting signal of the program is same as the rating information of analog broadcasting by the CPU 14 executing the rating information type determination program 16E.

Furthermore, for example, the recording control program 161D is a program to make the CPU 14 realize the function of controlling the record replay unit 11 so as to store the video/audio data of the program to which the parental control information of the parental control level determined by the CPU 14 executing the level determination program 161B in the recording medium by the CPU 14 executing the parental control information superimposing program 161C when it is determined that the type of the rating information included in the television broadcasting signal of the program is the rating information specific to digital broadcasting different from the rating information of analog broadcasting by the CPU 14 executing the rating information type determination program 16E.

The CPU 14 functions as a storage controlling unit by executing the recording control program 161D.

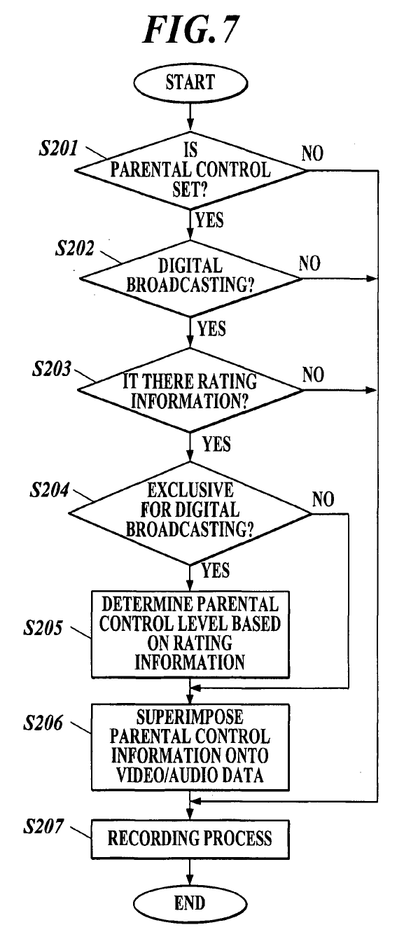

Next, the operation of storing the video/audio data in the storage medium in the television broadcasting recording apparatus 300 having a structure as described above will be described with reference to the flowchart shown in FIG. 7.

First, the CPU 14 determines whether the parental control is set or not by determining whether the rating information of the parental control level which restricts the viewing in the television broadcasting recording apparatus 100 is stored in the rating setting data file 16A or not (step S201) by the CPU 14 executing the setting determination program 16B.

When the CPU 14 determines that the parental control is not set in step S201 (step S201; No), the process proceeds to step S207.

When the CPU 14 determines that the parental control is set in step S201 (step S201; Yes), the CPU 14 determines whether the program is digital broadcasting or not by referring to the program information included in the television broadcasting signal of the program which is received by the antenna 1 and decoded by the decoder 4 (step S202) by the CPU 14 executing the broadcasting type determination program 16C.

When the CPU 14 determines that the program received by the antenna 1 is analog broadcasting in step S202 (step S202; No), the process proceeds to step S207.

When the CPU 14 determines that the program received by the antenna 1 is digital broadcasting in step S202 (step S202; Yes), the CPU 14 determines whether the rating information is added to the video/audio data of the program or not by controlling the detection unit 5 (step S203) by the CPU 14 executing the rating information detection program 16D.

When the CPU 14 determines that the rating information is not added to the video/audio data of the program in step S203 (step S203; No), the process proceeds to step S207.

When the CPU 14 determines that the rating information is added to the video/audio data of the program in step S203 (step S203; Yes), the CPU 14 determines whether the rating information is the rating information specific to digital broadcasting different from the rating information of analog broadcasting or not based on the existence or non-existence of the name and the version of the rating information which is detected by the detection unit 5 (step S204) by the CPU 14 executing the rating information type determination program 16E.

When the CPU 14 determines that the rating information included in the television broadcasting signal of the program received by the antenna 1 is same as the rating information of analog broadcasting in step S204 (step S204; No), the process proceeds to step S206.

When the CPU 14 determines that the rating information included in the television broadcasting signal of the program received by the antenna 1 is the rating information specific to digital broadcasting in step S204 (step S204; Yes), the CPU 14 determines the parental control level of the analog rating information which corresponds to the parental control level of the rating information specific to digital broadcasting based on a predetermined criteria (step S205) by the CPU 14 executing the level determination program 161B.

Next, the CPU 14 superimposes the parental control information which corresponds to the rating information included in the television broadcasting signal of the program or the parental control information which corresponds to the parental control level determined by the CPU 14 executing the level determination program 161B onto the video/audio data (step S206) by the CPU 14 executing the parental control information superimposing program 161C.

Then, the CPU 14 controls the record replay unit 11 so as to store the video/audio data of the program in the recording medium (step S207) by the CPU 14 executing the recording control program 16H.

According to the television broadcasting recording apparatus 300 of the above described third embodiment of the present invention, the rating information regarding the parental control level of the program is detected from the television broadcasting signal of the program which is received by the antenna 1 by controlling the detection unit 5 by the CPU 14 executing the rating information detection program 16D, the type of the rating information detected by the detection unit 5 is determined by the CPU 14 executing the rating information type determination program 16E, the parental control level of the analog rating information which corresponds to the parental control level of the rating information specific to digital broadcasting is determined based on the predetermined criteria by the CPU 14 executing the level determination program 161B when it is determined that the rating information included in the television broadcasting signal of the program is the rating information specific to digital broadcasting different from the rating information of analog broadcasting by the CPU 14 executing the rating information type determination program 16E, the parental control information of the parental control level of the analog rating information determined by the CPU 14 executing the level determination program 161B is superimposed to the video/audio data of the program to which the rating information specific to digital broadcasting is added by the CPU 14 executing the parental control information superimposing program 161C, and the video/audio data to which the parental control information is superimposed by the CPU 14 executing the parental control information superimposing program 161C is stored in the storage medium by the record replay unit 11. Therefore, the parental control can be more surely effective when the video/audio data of the program to which the rating information specific to digital broadcasting is added is stored in the storage medium as analog data because even the video/audio data of the program to which the rating information specific to digital broadcasting different from the rating information of analog is added can be stored in the storage medium by having the parental control information superimposed onto the video/audio data.

Here, the television broadcasting recording apparatus of the present invention may be anything as long as viewing and listening of the video and audio based on the video/audio signal are restricted. For example, the television broadcasting recording apparatus of the present invention may be a digital television having a function of carrying out the record replay such as the DVD, the VHS or the like, a set top box having a function of carrying out the record replay such as the DVD, the VHS or the like, or the like.

Moreover, the television broadcasting recording apparatus of the present invention can be applied to a television broadcasting recording system which comprises the record replay apparatus which carries out the record replay such as the DVD, the VHS or the like, and a digital television, a set top box or the like which is connected to the record replay apparatus.

According to a first aspect of the preferred embodiments of the present invention, there is provided a television broadcasting recording apparatus comprising a receiving unit to receive a digital television broadcasting signal, a storage unit to store a video/audio data of a program based on the television broadcasting signal received by the receiving unit in a storage medium as an analog data, an assigning unit to assign a reserved program to be stored in the storage medium by the storage unit, a reservation unit to store reservation information of the reserved program which is assigned by the assigning unit, by obtaining the reservation information from an electric program guide data, an obtaining unit to obtain rating information regarding a parental control level of the reserved program which is assigned by the assigning unit from the electric program guide data, a rating information type determination unit to determine a type of the rating information which is obtained by the obtaining unit, a display unit to display a predetermined warning display on the display unit when it is determined that the rating information of the program which is assigned by the assigning unit is the rating information specific to digital broadcasting different from the rating information of analog broadcasting by the rating information type determination unit, an input unit to input secret information and a secret information storage unit to store the secret information in advance, and the reservation unit stores the reservation information of the program in the reservation storage unit only in a case where the secret information input by the input unit matches with the secret information stored in the secret information storage unit when it is determined that the rating information of the program which is assigned by the assigning unit is the rating information specific to the digital broadcasting different from the rating information of the analog broadcasting by the rating information type determination unit.

In accordance with the first aspect of the preferred embodiments of the present invention, the reserved program which is to be stored in the storage medium by the storage unit is assigned by the assigning unit, the reservation information of the reserved program which is assigned by the assigning unit is obtained from the electric program guide data and is stored in the reservation storage unit by the reservation unit, the rating information regarding the parental control level of the reserved program which is assigned by the assigning unit is obtained from the electric program guide data by the obtaining unit, and the type of the rating information obtained by the obtaining unit is determined by the rating information type determination unit. Further, the reservation information of the program to which the rating information specific to digital broadcasting different from the rating information of analog broadcasting is added is not stored in the reservation storage unit by the reservation unit because the reservation information of the program is not stored in the reservation storage unit when it is determined that the rating information of the reserved program which is assigned by the assigning unit is the rating information specific to digital broadcasting different from analog broadcasting by the rating information type determination unit. Therefore, the video/audio data of the program to which the rating information specific to digital broadcasting different from the rating information of analog broadcasting can be prevented from being stored in the storage medium without having the parental control information superimposed, and the parental control can be more surely effective when the video/audio data of the program to which the rating information specific to digital broadcasting is added is stored in the storage medium as an analog data.

Further, the predetermined warning display is displayed on the display unit by the display control unit when it is determined that the rating information of the program assigned by the assigning unit is the rating information specific to digital broadcasting different from the rating information of analog broadcasting by the rating information type determination unit. Therefore, it can be prevented from falsely recognizing as a breakdown by visually recognizing the predetermined warning display which is displayed on the display unit even when the reservation information of the program to which the rating information specific to digital broadcasting different from the rating information of analog broadcasting is added is not stored in the reservation storage unit.

Moreover, the secret information is input by the input unit, the secret information is stored in advance by the password storage unit, and the reservation information of the program is stored in the reservation storage unit by the reservation unit only when the secret information input by the input unit matches with the secret information stored in the secret information storing unit in a case where it is determined that the rating information of the program which is assigned by the assigning unit is the rating information specific to digital broadcasting different from the rating information of analog broadcasting by the rating information type determination unit. Therefore, the television broadcasting recording apparatus is convenient to use because a person who can input the password can set the reservation for a program even when it is a program to which the rating information specific to digital broadcasting different from the rating information of analog broadcasting is added.

According to a second aspect of the preferred embodiments of the present invention, there is provided a television broadcasting recording apparatus comprising a receiving unit to receive a digital television broadcasting signal, a storage unit to store a video/audio data of a program based on the television broadcasting signal received by the receiving unit in a storage medium as an analog data, a detection unit to detect rating information regarding a parental control level of the program from the television broadcasting signal which is received by the receiving unit, a rating information type determination unit to determine a type of the rating information which is detected by the detection unit and a storage control unit to control the storage unit so as to prohibit storing of the video/audio data of the program in the storage medium when it is determined that the rating information of the program is rating information specific to digital broadcasting different from rating information of analog broadcasting by the rating information type determination unit.

In accordance with the second aspect of the preferred embodiments of the present invention, the rating information regarding the parental control level of the program is detected from the television broadcasting signal of the program received by the receiving unit by the detecting unit, the type of the rating information which is detected by the detection unit is determined by the rating information type determination unit, and the video/audio data of the program to which the rating information specific to digital broadcasting different from the rating information of analog broadcasting is not stored in the storage medium because the storage unit is controlled so as to prohibit the storing of the video/audio data of the program in the storage medium by the storage control unit when it is determined that the rating information of the program is the rating information specific to digital broadcasting different from the rating information of analog broadcasting. Therefore, the storing of the video/audio data of the program to which the rating information specific to digital broadcasting different from the rating information of analog broadcasting is added in the storage medium without having the parental control information superimposed can be prevented, and the parental control can be more surely effective when the video/audio data of the program to which the rating information specific to digital broadcasting is added is stored in the storage medium as an analog data.

Preferably, the television broadcasting recording apparatus further comprises a display control unit to display a predetermined warning display on a display unit by the rating information type determination unit when it is determined that the rating information of the program which is detected by the detection unit is the rating information specific to the digital broadcasting different from the rating information of the analog broadcasting.

In the present invention, the same effect can be obtained. Specifically, the predetermined warning display is displayed on the display unit by the display control unit when it is determined that the rating information of the program which is detected by the detection unit is the rating information specific to digital broadcasting different from the rating information of analog broadcasting by the rating information type determination unit. Therefore, it can be prevented from falsely recognizing as a breakdown by visually recognizing the predetermined warning display which is displayed on the display unit even when the video/audio data of the program to which the rating information specific to digital broadcasting different from the rating information of analog broadcasting is added is not stored in the storage unit.

According to a third aspect of the preferred embodiments of the present invention, there is provided a television broadcasting recording apparatus comprising a receiving unit to receive a digital television broadcasting signal, a storage unit to store a video/audio data of a program based on the television broadcasting signal received by the receiving unit in a storage medium as an analog data, an assigning unit to assign a reserved program to be stored in the storage medium by the storage unit, a reservation unit to store reservation information of a reserved program which is assigned by the assigning unit in a reservation storage unit by obtaining the reservation information from an electric program guide data, an obtaining unit to obtain rating information regarding a parental control level of the reserved program which is assigned by the assigning unit from the electric program guide data and a rating information type determination unit to determine a type of the rating information which is obtained by the obtaining unit, and the reservation unit does not store the reservation information of the program in the reservation storage unit when it is determined that the rating information of the reserved program which is assigned by the assigning unit is rating information specific to digital broadcasting different from the rating information of analog broadcasting by the rating information type determination unit.

In accordance with the third aspect of the preferred embodiments of the present invention, the reserved program to be stored in the storage medium by the storage unit is assigned by the assigning unit, the reservation information of the reserved program which is assigned by the assigning unit is obtained from the electric program guide data and is stored in the reservation storage unit by the reservation unit, the rating information regarding the parental control level of the reserved program which is assigned by the assigning unit is obtained from the electric program guide data by the obtaining unit, the type of the rating information obtained by the obtaining unit is determined by the rating information type determination unit, and the reservation information of the program to which the rating information specific to digital broadcasting different from the rating information of analog broadcasting is not stored in the reservation storage unit by the reservation unit because the reservation information of the program is not stored in the reservation storage unit when it is determined that the rating information of the reserved program which is assigned by the assigning unit is the rating information specific to digital broadcasting different from the rating information of analog broadcasting by the rating information type determination unit. Therefore, the storing of the video/audio data of the program to which the rating information specific to digital broadcasting different from the rating information of analog broadcasting is added in the storage medium without having the parental control information superimposed can be prevented, and the parental control can be more surely effective when the video/audio data of the program to which the rating information specific to digital broadcasting is added is stored in the storage medium as an analog data.

Preferably, the television broadcasting recording apparatus further comprises a display control unit to display a predetermined warning display on a display unit when it is determined that the rating information of the program which is assigned by the assigning unit is the rating information specific to the digital broadcasting different from the rating information of the analog broadcasting by the rating information type determination unit.

In the present invention, the same effect can be obtained. Specifically, the predetermined warning display is displayed on the display unit by the display control unit when it is determined that the rating information of the program which is assigned by the assigning unit is the rating information specific to digital broadcasting different from the rating information of analog broadcasting by the rating information type determination unit. Therefore, even when the reservation information of the program to which the rating information specific to digital broadcasting different from analog broadcasting is added is not stored in the reservation storage unit, it can be prevented from falsely recognizing as a breakdown by visually recognizing the predetermined warning display which is displayed on the display unit.

Preferably, the television broadcasting recording apparatus further comprises an input unit to input a secret information and a secret information storage unit to store the secret information in advance, and the reservation unit stores the reservation information of the program in the reservation storage unit in a case where the secret information input by the input unit matches with the secret information stored in the secret information storage unit when it is determined that the rating information of the program which is assigned by the assigning unit is the rating information specific to the digital broadcasting different from the rating information of the analog broadcasting by the rating information type determination unit.

In the present invention, the same effect can be obtained. Specifically, the secret information is input by the input unit, the secret information is stored in advance by the password storage unit, and the reservation information of the program is stored in the reservation storage unit by the reservation unit only when the secret information input by the input unit matches with the secret information stored in the secret information storage unit in the case where it is determined that the rating information of the program which is assigned by the assigning unit is the rating information specific to digital broadcasting different from the rating information of analog broadcasting by the rating information type determination unit. Therefore, the television broadcasting recording apparatus is convenient because a person who can input the password can set the reservation even when the program is a program to which the rating information specific to digital broadcasting different from the rating information of analog broadcasting is added.

According to a forth aspect of the preferred embodiments of the present invention, there is provided a television broadcasting recording apparatus comprising a receiving unit to receive a digital television broadcasting signal, a storage unit to store a video/audio data based on the television broadcasting signal of the program which is received by the receiving unit as an analog data, a detection unit to detect rating information regarding a parental control level of the program from the television broadcasting signal of the program which is received by the receiving unit, a rating information type determination unit to determine a type of the rating information which is detected by the detection unit, a determination unit to determine a parental control level of an analog rating information which corresponds to a parental control level of the rating information of the digital broadcasting based on a predetermined criteria when it is determined that the rating information included in the television broadcasting signal of the program is the rating information specific to the digital broadcasting different from the rating information of the analog broadcasting by the rating information type determination unit and a superimposing unit to superimpose parental control information of the parental control level of the analog rating information which is determined by the determination unit onto a video/audio data of a program to which the rating information specific to the digital broadcasting is added, and the storage unit stores the video/audio data to which the parental control information is superimposed by the superimposing unit in the storage medium.

In accordance with the forth aspect of the present invention, the rating information regarding the parental control level of the program is detected from the television broadcasting signal of the program which is received by the receiving unit by the detection unit, the type of the rating information detected by the detection unit is determined by the rating information type determination unit, the parental control level of the analog rating information which corresponds to the parental control level of the rating information specific to digital broadcasting is determined based on the predetermined criteria by the determination unit when it is determined that the rating information included in the television broadcasting signal of the program is the rating information specific to digital broadcasting different from the rating information of analog broadcasting by the rating information type determination unit, the parental control information of the parental control level of the analog rating information which is determined by the determination unit is superimposed onto the video/audio data of the program to which the rating information specific to digital broadcasting is added by the superimposing unit, and the video/audio data to which the parental control information is superimposed by the superimposing unit is stored in the storage medium by the storage unit. Therefore, the video/audio data can be stored in the storage medium by having the parental control information superimposed even when it is a video/audio data of the program to which the rating information specific to digital broadcasting different from the rating information of analog broadcasting is added, and the parental control can be more surely effective when the video/audio data of the program to which the rating information specific to digital broadcasting is added is stored in the storage medium as an analog data.

The entire disclosure of Japanese Paten Application No. 2006-284067 filed on Oct. 18, 2006 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A television broadcasting recording apparatus, comprising:
a receiving unit to receive a digital television broadcasting signal;
a storage unit to store a video/audio data of a program based on the television broadcasting signal received by the receiving unit in a storage medium as an analog data;
an assigning unit to assign a reserved program to be stored in the storage medium by the storage unit;
a reservation unit to store reservation information of the reserved program which is assigned by the assigning unit, by obtaining the reservation information from an electric program guide data;
an obtaining unit to obtain rating information regarding a parental control level of the reserved program which is assigned by the assigning unit from the electric program guide data;
a rating information type determination unit to determine a type of the rating information which is obtained by the obtaining unit;
a display unit to display a predetermined warning display on the display unit when it is determined that the rating information of the program which is assigned by the assigning unit is the rating information specific to digital broadcasting different from the rating information of analog broadcasting by the rating information type determination unit;
an input unit to input secret information; and
a secret information storage unit to store the secret information in advance, wherein
the reservation unit stores the reservation information of the program in the reservation storage unit only in a case where the secret information input by the input unit matches with the secret information stored in the secret information storage unit when it is determined that the rating information of the program which is assigned by the assigning unit is the rating information specific to the digital broadcasting different from the rating information of the analog broadcasting by the rating information type determination unit.

2. A television broadcasting recording apparatus, comprising:
a receiving unit to receive a digital television broadcasting signal;
a storage unit to store a video/audio data of a program based on the television broadcasting signal received by the receiving unit in a storage medium as an analog data;
a detection unit to detect rating information regarding a parental control level of the program from the television broadcasting signal which is received by the receiving unit;
a rating information type determination unit to determine a type of the rating information which is detected by the detection unit; and
a storage control unit to control the storage unit so as to prohibit storing of the video/audio data of the program in the storage medium when it is determined that the rating information of the program is rating information specific to digital broadcasting different from rating information of analog broadcasting by the rating information type determination unit.

3. The television broadcasting recording apparatus as claimed in claim 2, further comprising:
a display control unit to display a predetermined warning display on a display unit by the rating information type determination unit when it is determined that the rating information of the program which is detected by the detection unit is the rating information specific to the digital broadcasting different from the rating information of the analog broadcasting.

4. A television broadcasting recording apparatus, comprising:
a receiving unit to receive a digital television broadcasting signal;
a storage unit to store a video/audio data of a program based on the television broadcasting signal received by the receiving unit in a storage medium as an analog data;
an assigning unit to assign a reserved program to be stored in the storage medium by the storage unit;
a reservation unit to store reservation information of a reserved program which is assigned by the assigning unit in a reservation storage unit by obtaining the reservation information from an electric program guide data;
an obtaining unit to obtain rating information regarding a parental control level of the reserved program which is assigned by the assigning unit from the electric program guide data; and
a rating information type determination unit to determine a type of the rating information which is obtained by the obtaining unit, wherein
the reservation unit does not store the reservation information of the program in the reservation storage unit when it is determined that the rating information of the reserved program which is assigned by the assigning unit is rating information specific to digital broadcasting different from the rating information of analog broadcasting by the rating information type determination unit.

5. The television broadcasting recording apparatus as claimed in claim 4, further comprising:
a display control unit to display a predetermined warning display on a display unit when it is determined that the rating information of the program which is assigned by the assigning unit is the rating information specific to the digital broadcasting different from the rating information of the analog broadcasting by the rating information type determination unit.

6. The television broadcasting recording apparatus as claimed in claim 4, further comprising:
an input unit to input a secret information; and
a secret information storage unit to store the secret information in advance, wherein
the reservation unit stores the reservation information of the program in the reservation storage unit in a case where the secret information input by the input unit matches with the secret information stored in the secret information storage unit when it is determined that the rating information of the program which is assigned by the assigning unit is the rating information specific to the digital broadcasting different from the rating information of the analog broadcasting by the rating information type determination unit.

7. A television broadcasting recording apparatus, comprising:
a receiving unit to receive a digital television broadcasting signal;
a storage unit to store a video/audio data based on the television broadcasting signal of the program which is received by the receiving unit as an analog data;
a detection unit to detect rating information regarding a parental control level of the program from the television broadcasting signal of the program which is received by the receiving unit;
a rating information type determination unit to determine a type of the rating information which is detected by the detection unit;
a determination unit to determine a parental control level of an analog rating information which corresponds to a parental control level of the rating information of the digital broadcasting based on a predetermined criteria when it is determined that the rating information included in the television broadcasting signal of the program is the rating information specific to the digital broadcasting different from the rating information of the analog broadcasting by the rating information type determination unit; and
a superimposing unit to superimpose parental control information of the parental control level of the analog rating information which is determined by the determination unit onto a video/audio data of a program to which the rating information specific to the digital broadcasting is added, wherein
the storage unit stores the video/audio data to which the parental control information is superimposed by the superimposing unit in the storage medium.
